(19) United States
(12) Patent Application Publication
(10) Pub. No.: US 2006/0039673 A1
(43) Pub. Date: Feb. 23, 2006

(54) Video playback apparatus and method

(75) Inventors: Hsin-Jung Chuang, Hsinchu (TW); Yu-Hung Sun, Hsinchu (TW)

Correspondence Address: MADSON & AUSTIN;GATEWAY TOWER WEST, SUITE 900, 15 WEST SOUTH TEMPLE, SALT LAKE CITY, UT, 84101, US

(73) Assignee: Lite-On It Corp.

(21) Appl. No.: 11/204,199

(22) Filed: Aug. 15, 2005

(30) Foreign Application Priority Data
Aug. 17, 2004 (TW) 093124728

(51) Int. Cl. H04N 5/91

(52) U.S. Cl. 386/46

(57) ABSTRACT

A video playback apparatus includes a magnetic head, a transmission device and a memorizing device. The magnetic head is in contact with and rotates on a tape of a magnetic videotape to read data to be shown on a display in a reading procedure, and is separate from the tape of the magnetic videotape in a pause state. The transmission device engages with the tape of the magnetic videotape for guiding the tape to be in contact with or separate from the magnetic head, and transmits the tape to pass the magnetic head in the reading procedure. The memorizing device memorizes and outputs the latest frame data to the display in the pause state.

### FIELD OF THE INVENTION

The present invention relates to a video playback apparatus and method, and more particularly to a magnetic-tape type video recorder/player and the playback method thereof.

### BACKGROUND OF THE INVENTION

VCR (Video Cassette Recorder) and VTR (Video Tape Recorder) both used to be popular video playback apparatus. The difference between VCR and VTR is that the tape of VCR needs to be reversed or rewound by reversing the magnetic head and/or motor after the tape has run out, while the tape of VTR can cycle over and over as long as power keeps supplied. Nowadays, conventional VTRs with cyclic tapes have disappeared from the market, and the terms VTR and VCR both mean the playback apparatus of the cassette type.

Compared to VTR or VCR playback apparatus, digital video recorder/players are commercially available now and getting more and more popular. Although it is a trend to commercially replace digital video playback apparatus for VTR or VCR playback apparatus, the VTR or VCR playback apparatus is still in demand because there are still many video products kept in cassette forms in homes, schools, TV stations, etc. Therefore, it is still necessary to improve the functions of the VTR or VCR playback apparatus in consideration of the precious videotapes.

One of the disadvantages in using a VTR or VCR playback apparatus is the abrasion problem. As known, a magnetic head 10 of a VTR or VCR playback apparatus has to keep contact with and rotate on a tape 11 with the facilitation of rollers 12 for reading data from the tape or recording data into the tape, as shown in FIGS. 1(a) and 1(b). Even when the VTR or VCR playback apparatus is in a pause state, the magnetic head still has to rotate on the tape in order to show the current frame in a still mode. The physical contact and relative movement between the magnetic head and the tape will result in more or less abrasion of the tape or magnetic head. Accumulatively, it is likely to damage the data stored in the tape or fail the reading operation.

### SUMMARY OF THE INVENTION

Therefore, the present invention provides a video playback apparatus that is capable of showing a still frame while disengaging the magnetic head from the tape in a pause state, thereby minimizing the abrasion problem.

The present invention relates to a video playback apparatus, which comprises a first video player sequentially generating first video signals to be shown on a display in response to a series of data read from a magnetic videotape in a reading procedure; and a memorizing device coupled to the first video player for memorizing and outputting the latest one of the first video signals to the display in a pause state.

In an embodiment, the first video player comprises a magnetic head and a transmission device. The magnetic head is in contact with and rotates on a tape of the magnetic videotape, where the data to be read are recorded, in the reading procedure, and is separate from the tape of the magnetic videotape in the pause state. The transmission device engages with the tape of the magnetic videotape for transmitting the tape and guides the tape to be in contact with or separate from the magnetic head.

In an embodiment, the transmission device comprises a roller set for transmitting the tape of the magnetic videotape to pass the magnetic head in the reading procedure and a guiding track. The guiding track allows the roller set to move therealong between a reading position where the tape of the magnetic videotape is in contact with the magnetic head and a pause position where the tape of the magnetic videotape is separate from the magnetic head. The roller set stops rotating while the magnetic head keeps on rotating in the pause state.

In an embodiment, the roller set includes two rollers disposed at opposite sides of the magnetic head, and the guiding track includes two slot members movably receiving therein the two rollers, respectively. Each of the two slot members has a first end close to the magnetic head and a second end distant from the magnetic head so as to guide the rollers to move between the first end and the second end as the reading position and the pause position, respectively.

When the first video signals are analog signals and the memorizing device memorizes a digital signal converted from the latest one of the first video signals, the video playback apparatus preferably further comprises a central processing unit (CPU) coupled to the first video player and the memorizing device for converting the latest one of the first video signals into the digital signal.

In an embodiment, the memorizing device is a data buffer built in the CPU. A graphics processor in communication with the data buffer receives and converts the digital signal stored in the data buffer into a second video signal consistent with a specification of the display, and outputs the second video signal to the display. The second video signal can be an analog signal that is outputted to the display in an overlay frame manner.

In an embodiment, the video playback apparatus further comprises a second video player coupled to the CPU and sequentially generating digital video signals to be shown on the display in response to a series of data read from a digital video disc in another reading procedure. The first video signals are converted into digital forms by the CPU and recorded into a digital optical disc via the second video player in a transcription procedure.

In an embodiment, the first video player and the second video player are installed in the same housing of the video playback apparatus.

The present invention provides another video playback apparatus, which comprises a magnetic head being in contact with and rotating on a tape of a magnetic videotape to read data to be shown on a display in a reading procedure, and being separate from the tape of the magnetic videotape in a pause state; a transmission device engaging with the tape of the magnetic videotape for guiding the tape to be in contact with or separate from the magnetic head, and transmitting the tape to pass the magnetic head in the reading procedure; and a memorizing device for memorizing and outputting the latest frame data to the display in the pause state. The video playback apparatus may further comprise a CPU for converting data read from the tape of the magnetic videotape into digital data, wherein the memorizing device is a data buffer built in the CPU; and a graphics processor in communication with the data buffer for receiving and converting the digital data into a video signal consistent with a specification of the display, and outputting the video signal to the display in an overlay frame manner.

The present invention further provides a video playback method. In the method, a tape of a magnetic videotape is transmitted to move and a magnetic head of a video playback apparatus rotates on the moving tape to read data from the tape when the video playback apparatus is in a reading procedure. Afterwards, when the video playback apparatus enters a pause state, the magnetic head is separated from the tape. Meanwhile, the latest data read from the tape is memorized. Updated data generated by the magnetic head is shown on the display when the video playback apparatus is in the reading procedure, and the memorized data is shown on the display when the video playback apparatus is in the pause state.

In an embodiment, data is read from the tape in a first analog form and memorized in a digital form, and the method further comprises a step of converting the latest data read from the tape into the digital form before the memorizing step.

In an embodiment, data is shown on the display in a second analog form, and the method further comprises a step of converting the updated data and the memorized data into the second analog form before the showing steps.

### BRIEF DESCRIPTION OF THE DRAWINGS

The present invention may best be understood through the following description with reference to the accompanying drawings, in which:

FIG. 1(a) is a schematic diagram showing how a magnetic head works with a tape to read/record data according to prior art;

FIG. 1(b) is a partially enlarged perspective view of FIG. 1(a) schematically showing the coupling of the magnetic head to the tape via a pair of rollers;

FIG. 2 is a functional block diagram showing a first embodiment of a video playback apparatus according to the present invention;

FIG. 3(a) is a schematic diagram illustrating the relative positions of the magnetic head and the tape in a normally reading procedure;

FIG. 3(b) is a schematic diagram illustrating the relative positions of the magnetic head and the tape in a pause state; and

FIG. 4 is a functional block diagram showing a second embodiment of a video playback apparatus according to the present invention.

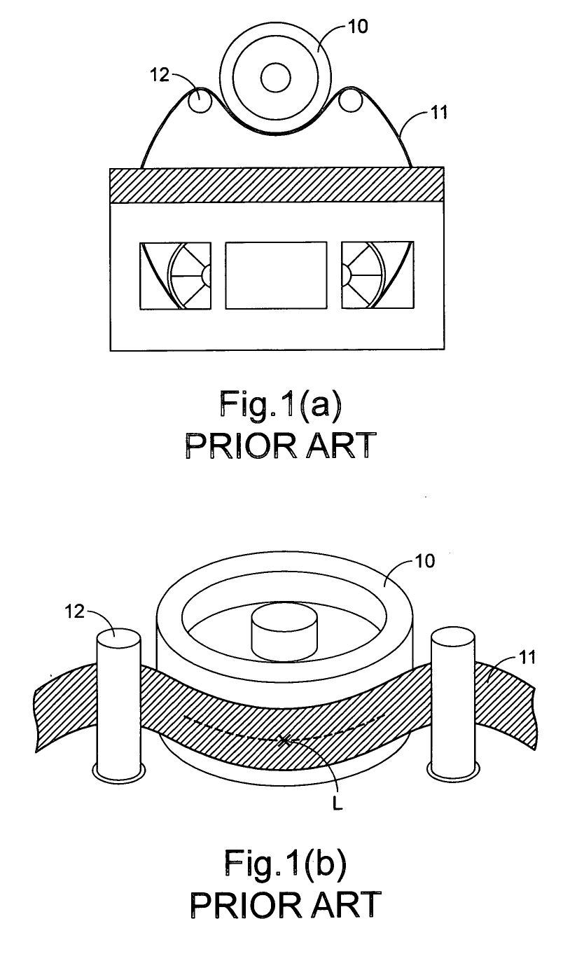

### DETAILED DESCRIPTION OF THE PREFERRED EMBODIMENT

The present invention will now be described more specifically with reference to the following embodiments. It is to be noted that the following descriptions of preferred embodiments of this invention are presented herein for purpose of illustration and description only; it is not intended to be exhaustive or to be limited to the precise form disclosed.

According to the present invention, in order to show a still frame while disengaging the magnetic head from the tape when the video playback apparatus is in a pause state, the still frame is memorized when a pause function is enabled. Then, the magnetic head can be moved away from the tape.

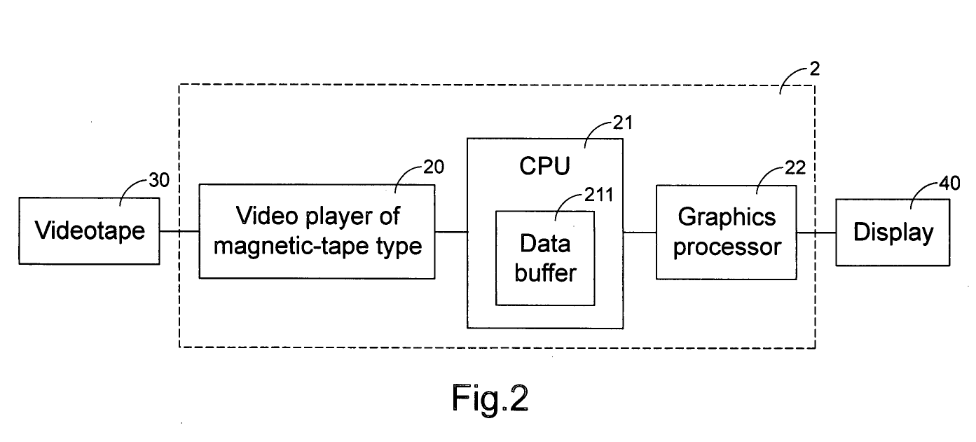

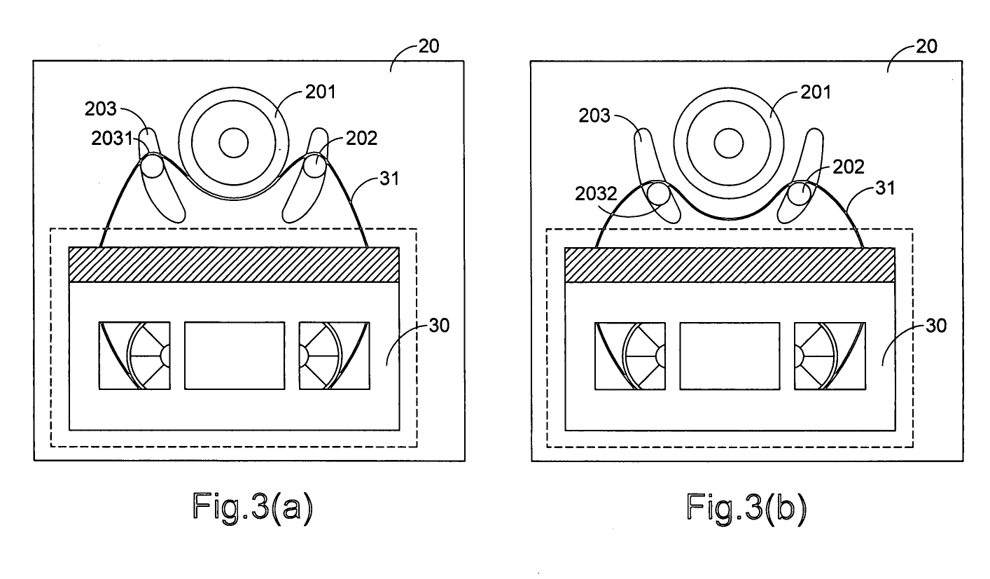

Hereinafter, an embodiment of the present invention will be described with reference to FIG. 2. In this embodiment, the video playback apparatus 2 includes a video player 20 for playback of a magnetic-type videotape 30. Further, a CPU 21 and a graphics processor 22 are provided in the video playback apparatus 2. In a normally reading procedure, a magnetic head 201 of the video player 20 is in contact with and rotating on the tape 31 of the videotape 30, as illustrated in FIG. 3(a), so as to generate continually updated analog video signals. Afterwards, when the video playback apparatus is switched into a pause state, the video analog signal corresponding to the current frame is inputted into the CPU 21 to be converted into a digital form. The video digital signal is then transmitted to the graphics processor 22 to be processed into a proper form for display, e.g. another analog video signal. Since the still frame has been memorized, the still frame can thus be shown on a display 40 such as a TV screen without continuous contact of the magnetic head 201 with the tape to repetitively read the data of the still frame. Such configuration is illustrated in FIG. 3(b). As shown, the rollers 202 are disposed at opposite sides of the magnetic head 201 and slide along respective tracks 203 from a first end 2031 to a second end 2032 to retract from the magnetic head 201 so as to make the magnetic head 201 separate from the tape 31.

The video playback apparatus 2 mentioned above further includes a data buffer 211 built in the CPU 21. Therefore, the digital video signals converted by the CPU 21 from the analog video signals generated by the video player 20 can be sequentially registered in the data buffer 211 and sequentially processed into overlay frames by the graphics processor 22. Once a pause function is entered, for example by actuating a pause key or button, the last digital video signal is transmitted to the graphics processor 22 to be processed into another format of video signal suitable for display, e.g. a TV analog signal, thereby showing the last frame on a TV screen stilly. Meanwhile, the magnetic head 201 is separated from the tape 31.

The present invention, in addition to solving the abrasion problem, also solves the frame-jiggling and noise problems of conventional video recorder/player of a magnetic-tape type in a pause state. It is because the frame is digitally stored and repetitively overlays previous identical frame instead of repetitively rereading data from the videotape with the magnetic head.

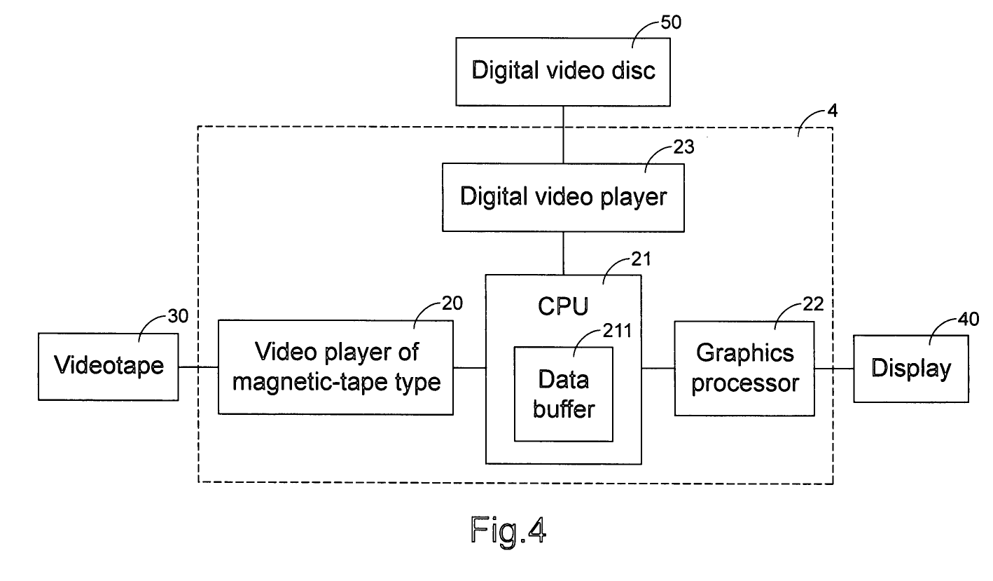

In general, a digital video playback apparatus has better reading and recording quality and is beneficial in preservation and edition of data. Therefore, a transcription technology is developed to rerecord and/or edit the data stored in the VTR or VCR cassettes in a digital form. This technology is feasible by digitizing the data with simulated analog signals. FIG. 4 schematically illustrates a video playback apparatus 4 that can do a transcription operation from the videotape 30 to a digital video disc 50. Of course, if desired, it can also do a transcription operation from the digital video disc 50 to the videotape 30.

The video playback apparatus 4 includes a video player of a magnetic-tape type 20, a CPU 21 having a data buffer 211 therein and a graphics processor 22 similar to aforementioned equivalents. In addition, the video playback apparatus 4 includes a digital video player 23 for playback of a digital video disc 50, which is disposed in the same housing along with the above devices or elements. Further, in this embodiment, the video data to be displayed can be originated from either the digital video player 23 or the video player of a magnetic-tape type 20, digitally or analog converted by the CPU 21 and processed by the graphics processor 22. The transcription operations between the digital video disc 50 and the videotape 30 can be done by the CPU 21. Moreover, when either of the video players 20 and 23 is switched into a pause state, the last frame will be stored in the data buffer and keep shown on the display 40. Meanwhile, the magnetic head of the video player 20 and the tape of the videotape 30 will be in a disengaging configuration. Therefore, the abrasion problem can be abbreviated.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A video playback apparatus, comprising:
a first video player sequentially generating first video signals to be shown on a display in response to a series of data read from a magnetic videotape in a reading procedure; and
a memorizing device coupled to said first video player for memorizing and outputting the latest one of said first video signals to the display in a pause state.

2. The video playback apparatus according to claim 1 wherein said first video player comprises:
a magnetic head being in contact with and rotating on a tape of the magnetic videotape, where the data to be read are recorded, in said reading procedure, and being separate from the tape of the magnetic videotape in said pause state; and
a transmission device engaging with the tape of the magnetic videotape for transmitting the tape and guiding the tape to be in contact with or separate from said magnetic head.

3. The video playback apparatus according to claim 2 wherein said transmission device comprises:
a roller set for transmitting the tape of the magnetic videotape to pass said magnetic head in said reading procedure; and
a guiding track allowing said roller set to move therealong between a reading position where the tape of the magnetic videotape is in contact with said magnetic head and a pause position where the tape of the magnetic videotape is separate from said magnetic head.

4. The video playback apparatus according to claim 3 wherein said roller set stops rotating while said magnetic head keeps on rotating in said pause state.

5. The video playback apparatus according to claim 3 wherein said roller set includes two rollers disposed at opposite sides of said magnetic head, and said guiding track includes two slot members movably receiving therein said two rollers, respectively.

6. The video playback apparatus according to claim 5 wherein each of said two slot members has a first end close to said magnetic head and a second end distant from said magnetic head so as to guide said rollers to move between said first end and said second end as said reading position and said pause position, respectively.

7. The video playback apparatus according to claim 1 wherein said first video signals are analog signals.

8. The video playback apparatus according to claim 7 wherein said memorizing device memorizes a digital signal converted from the latest one of said first video signals, and said video playback apparatus further comprises a central processing unit (CPU) coupled to said first video player and said memorizing device for converting the latest one of said first video signals into said digital signal.

9. The video playback apparatus according to claim 8 wherein said memorizing device is a data buffer built in said CPU.

10. The video playback apparatus according to claim 9 further comprising a graphics processor in communication with said data buffer for receiving and converting said digital signal stored in said data buffer into a second video signal consistent with a specification of the display, and outputting said second video signal to the display.

11. The video playback apparatus according to claim 10 wherein said second video signal is an analog signal that is outputted to the display in an overlay frame manner.

12. The video playback apparatus according to claim 8 further comprising a second video player coupled to said CPU and sequentially generating digital video signals to be shown on the display in response to a series of data read from a digital video disc in another reading procedure.

13. The video playback apparatus according to claim 12 wherein said first video signals are converted into digital forms by said CPU and recorded into a digital optical disc via said second video player in a transcription procedure.

14. The video playback apparatus according to claim 12 wherein said first video player and said second video player are installed in the same housing of the video playback apparatus.

15. A video playback apparatus, comprising:
a magnetic head being in contact with and rotating on a tape of a magnetic videotape to read data to be shown on a display in a reading procedure, and being separate from the tape of the magnetic videotape in a pause state;
a transmission device engaging with the tape of the magnetic videotape for guiding the tape to be in contact with or separate from said magnetic head, and transmitting the tape to pass said magnetic head in said reading procedure; and
a memorizing device for memorizing and outputting the latest frame data to the display in said pause state.

16. The video playback apparatus according to claim 15 further comprising:
a CPU for converting data read from the tape of the magnetic videotape into digital data, wherein said memorizing device is a data buffer built in said CPU; and
a graphics processor in communication with said data buffer for receiving and converting said digital data into a video signal consistent with a specification of the display, and outputting said video signal to the display in an overlay frame manner.

17. A video playback method, comprising steps of:
transmitting a tape of a magnetic videotape to move and rotating a magnetic head of a video playback apparatus on the moving tape to read data from the tape when the video playback apparatus is in a reading procedure;
separating the magnetic head from the tape when the video playback apparatus enters a pause state;
memorizing the latest data read from the tape before the video playback apparatus enters a pause state;
showing updated data generated by the magnetic head on the display when the video playback apparatus is in said reading procedure; and
showing said memorized data on the display when the video playback apparatus is in said pause state.

18. The method according to claim 17 wherein said updated data and said memorized data are shown on the display in an overlay frame manner.

19. The method according to claim 17 wherein data is read from the tape in a first analog form and memorized in a digital form, and the method further comprises a step of converting the latest data read from the tape into said digital form before the memorizing step.

20. The method according to claim 19 wherein data is shown on the display in a second analog form, and the method further comprises a step of converting said updated data and said memorized data into said second analog form before the showing steps.
